(19) United States
(12) Patent Application Publication
(10) Pub. No.: US 2004/0170163 A1
(43) Pub. Date: Sep. 2, 2004

(54) Data structure providing storage and bandwidth savings for hardware RTCP statistics collection applications

(75) Inventors: James Yik, Mission Viejo, CA (US); Lijen Ko, Irvine, CA (US)

Correspondence Address: LAW OFFICE OF LAWRENCE E LAUBSCHER, JR, 1160 SPA RD, SUITE 2B, ANNAPOLIS, MD, 21403, US

(73) Assignee: ZARLINK SEMICONDUCTOR V.N. INC., Irvine, CA

(21) Appl. No.: 10/376,412

(22) Filed: Feb. 28, 2003

(51) Int. Cl. H04L 12/56

(52) U.S. Cl. 370/389

(57) ABSTRACT

Data structures for efficient tracking Real-Time Control Protocol (RTCP) statistical information reported in connection with a Real-Time Protocol (RTP) encapsulated data stream, and a signaling protocol for updating corresponding statistical information between a hardware statistics information collection function and a software statistics information processing function is presented. Hardware data structure and software data structure specifications take into account: the arrival rate of RTCP statistics reports, the rate of generation of RTP packets, expected communication session duration, statistics information processing bandwidth, etc.; to provide a balance between hardware statistics information tracking, timely update of statistics information processed by software, while reducing statistics information update overheads in support of high density data streaming solutions.

### FIELD OF THE INVENTION

The invention relates to communications monitoring, and in particular methods and apparatus providing hardware statistics collection in support of conveying telephone quality voice data over packet-switched data transport networks.

### BACKGROUND OF THE INVENTION

In the field of telecommunications, telephone quality services such as the Plain Old Telephone Service (POTS) traditionally has been provisioned over circuit-switched signal transmission infrastructure. There is a current need to provision telephone quality streaming data services over packet-switched data transport infrastructure. There is substantial market pressure towards convergent technologies. Convergent technologies concern the merging of voice, data, and video service provisioning over the same transport infrastructure by integrating telecommunication and computer technologies. Moreover, there is a need to provide high density implementations supporting an ever increasing number of telecommunication sessions concurrently.

Circuit-switched communications and packet-switched communications are based on different operational principles optimizing different operational parameters. A quality-of-service is defined as a combination of operational parameter values. Circuit-switched communication attempts to provide zero-delay and zero-jitter signal transport, while packet-switched communication attempts to achieve bandwidth efficiency. The migration from traditional circuit-switched provisioning to packet-switched provisioning is a matter of intense current research and development. Although packet-switched transport adheres to different operational principles from circuit-switched technologies, there is a need to achieve the quality-of-service, traditionally provisioned over circuit-switched technologies, using packet-switched technologies.

Exemplary implementations of packet-switched telephone service provisioning solutions employ Voice-over-Internet Protocol (VoIP) technologies. VoIP technologies relate to conveying of VoIP packets in accordance with best-effort service level guarantees. As opposed to circuit-switched technologies, wherein telephone sessions are associated with dedicated end-to-end connections, audio sample groups conveyed by VoIP packets, route independently of each other in a packet-switched network. The aggregate audio sample groups form a data stream to be played back, at a destination end station, using computed playback times referenced to a clock associated with the destination end station.

As opposed to traditional telephone service provisioning over dedicated circuits ensuring transmission of voice samples at constant rates, VoIP telephone service provisioning is subject to a best-effort bursty conveyance of VoIP packets. Bursty transmission stems from the fact that each VoIP packet conveys a particular number of voice data samples in an audio sample group forming a VoIP packet payload. Early generated voice data samples accumulate in VoIP packet payloads waiting for later generated voice data samples before transmission thereof.

Other factors related to bursty transmission in packet-switched communications have to do with packet processing at network nodes in packet-switched networks. Packet processing introduces a processing delay in packet transmission. Internet Protocol (IP) packet transmission employs store-and-forward techniques whereby packets are stored pending processing. The storage of packets pending processing is subject to queuing techniques, queuing delays, queue service disciplines, etc. all of which introduce variable delays. The combination of these effects is evidenced in a variable packet interarrival time at destination end stations, referred to in the art as jitter.

The above factors have been addressed in connection with telephone service provisioning over packet-switched infrastructure and have been subject to improvement between which:

Co-pending commonly assigned U.S. patent application Ser. No. 10/103,299 filed Mar. 20th, 2002 entitled “Method of Detecting Drift Between Two Clocks” addresses issues related to dynamic synchronization of source and local clocks, and is incorporated herein by reference. Methods of, and apparatus for detecting drift between two clocks are described. The apparatus comprises a hardware implementation of a clock drift evaluator. The evaluator monitors received packets associated with a data stream, and extracts from each packet a time stamp generated by the source clock. A difference d between the extracted time stamp and the local time is compared against a d_ref value to determine whether the packet was received early or late. On a prescribed schedule, a degree of late or early receipt of packets is compared against a tolerance level to determine whether a relative drift exists between the pacing of the source clock and the pacing of the local clock. The detection of drift between the two clocks provides support for service level guarantees in provisioning data streaming services in packet-switched environments.

Co-pending commonly assigned U.S. patent application Ser. No. 10/139,644 filed May 7th, 2002, entitled “Time-Indexed Multiplexing as an Efficient Method of Scheduling in Hardware” addresses issues related to hardware process scheduling, and is incorporated herein by reference. The presented apparatus includes a table of task lists. Each task list holds specifications of processes requiring handling during a corresponding time interval. Each task list is parsed by a scheduler during a corresponding interval and the processes specified therein are handled. The presented process handling methods also include a determination of a next time interval in which the process requires handling and inserting of process specifications in task lists corresponding to the determined next handling time. Implementations are also presented in which task lists specify work units requiring handling during corresponding time intervals. The entire processing power of the scheduler is used to schedule processes for handling. Advantages are derived from an efficient use of the processing power of the scheduler as the number of processes is increased in support of high density applications.

Over and above the mentioned improvements, it is necessary to address the facts that best-effort IP packet transport does not guarantee the safe arrival of packets at the destination end, and that a transmitting station may opt to suppress transmission of VoIP packets otherwise conveying voice data samples having a low signal energy. Such silence suppression techniques are beneficial in reducing transmission bandwidth utilization. Nonetheless, at the receiving end station, non-availability of voice sample data for playback regardless of the reason for non-availability thereof results in silent playback. A reduced apparent quality-of-service is perceived when the audio playback is devoid of sound creating an eerie feeling. Comfort noise insertion techniques must be employed to enhance the perceived quality-of-service.

Having regard to the fact that human speech has an activity factor of about 0.4, about 60% of voice samples generated in digitizing human speech are silent. A substantial amount of development has been undertaken recently in generating comfort noise patterns—subject matter which is described elsewhere. Largely these recent developments have fallen short of providing suitable methods of inserting comfort noise patterns during playback. Comfort noise insertion at the destination end must take into account: silence suppression instances in the absence of received packets, dropped packet instances evidenced by the absence of received packets, late packet arrivals, etc. Having regard to convergent applications, there is a need to develop apparatus and methods for efficiently inserting comfort noise patterns into multiple voice streams concurrently and independently.

Co-pending commonly assigned U.S. patent application Ser. No. 10/195,657 filed Jul. 15, 2002 entitled “A Hardware Implementation of Voice-over-IP Playback with Support for Comfort Noise Insertion” provides playback scheduling solutions for voice data sample packet payloads conveyed over best-effort packet-switched infrastructure. The presented hardware implementation provides support for concurrent and independent comfort noise insertion and for dynamic clock adjustment for telephone sessions provisioned concurrently without making recourse to signaling. The apparatus and methods support high density solutions scaleing up to large numbers of concurrently provisioned telephone sessions.

In an attempt to further attempts to provide a high quality-of-service, feedback mechanisms are employed for assessing characteristics of the best-effort conveyance of VoIP packets in support of adaptive VoIP solutions.

The Real-Time Transport Protocol (RTP) is a session layer protocol that provides end-to-end network transport functions for applications exchanging real-time streaming data, such as but not limited to audio and video streaming, over packet-switched communications networks over multicast or unicast data transport services. The RTP protocol is described in RFC1889 and is incorporated herein by reference.

In multi-participant, multimedia applications such as video conferencing, the audio or video payload units 100 are prefixed with an RTP header 110, as schematically shown in FIG. 1, which includes a data stream source identifier 112, a payload type specifier 114 that indicates a data format (for example, the type of signal compression used, if any), a sequence number 116 used for bookkeeping and payload unit reordering, and a timestamp 118 used for stream re-timing and playback.

An associated Real-Time Control Protocol (RTCP) is used in conjunction with RTP to monitor in real-time the quality-of-service delivered and to convey information about participants of an ongoing video conferencing session. The RTCP protocol is also described in RFC 1889 and is incorporated herein by reference. For each RTP session, all participants—both sender and receiver stations—must periodically broadcast reporting information about themselves and their status.

The broadcasted reporting information includes: simple signals serving as an indication of either joining or leaving the conference context; a participant description including, but not limited to: a name, an email address, a phone number, etc.; or a statistics report.

Exemplary sender 200 and receiver 300 statistics reports are schematically shown in FIG. 2 and FIG. 3 respectively. The statistics reports specify for example the number of: packets sent 222, packets lost 224/324, interarrival jitter 226/326, etc.

In particular, the statistics reports 200/300 enable devices that assemble payloads, at network nodes in the path traversed by the packets, to trigger a real-time response to communications network conditions. Responses include for example changing signal compression ratio, adjusting video frame rate, adjusting video image size, and/or suppressing low-energy audio payloads (silence suppression).

Modern convergent devices, such as but not limited to media gateways, support an increasingly larger number of concurrent video/audio content RTP encapsulated streams. At a particular device, the aggregate packet processing rate is proportional to the number of concurrent streams processed. The RTCP statistics collection will need to be performed primarily in hardware to ensure a deterministic performance in processing received statistics information.

Hardware implementations are preferred in providing support for packet-switched streaming service provisioning. Hardware implementations benefit from a designed response time in processing VoIP packets.

However, in transmitting statistics information, RTCP packets are sent out infrequently. Typically statistics reports 300 are generated between once per second and once per minute. Therefore generation of statistics reports 300 and the formulation of RTCP packets in convergent devices is implemented in software.

Hardware statistics collection presents difficult problems for high density applications including: the amount of storage resources required to track statistical information; the bandwidth required to update the statistics store per packet transmitted or received; and the communication flow between the hardware collecting and tracking the statistical information, and the software processing and providing the real-time response.

There therefore is a need to solve the above mentioned issues.

### SUMMARY OF THE INVENTION

In accordance with an aspect of the invention, a hardware device processing Real-Time Control Protocol (RTCP) statistics in support of streaming services provisioned via packet-switched communications networks is provided. A plurality of data structures are used, each data structure tracking summary statistics information regarding a corresponding provisioned streaming service flow. A statistics block inspects, in real time, a Real-Time Protocol (RTP) encapsulated packet to extract RTCP statistics information therefrom to update a corresponding data structure. The statistics block encapsulates a streaming service flow payload with an RTP header updated with statistics information held in a data structure corresponding to the streaming service flow provisioned.

In accordance with another aspect of the invention, the device further includes a clock updating an address counter. The address counter specifies, on each tick of the clock, a streaming service flow for which the statistics information held in the corresponding data structure is scheduled to be reported to an external processor.

In accordance with a further aspect of the invention, the device comprises one of a media gateway communications network node, a media gateway component associated with a communications network node, a physical layer device associated with a communications network node, a physical port device, a single-chip physical port controller, a network appliance, and an IP phone.

In accordance with a further aspect of the invention, a method for tracking RTCP statistics is provided. Field values are extracted from an RTP packet header of a received packet corresponding to a streaming service flow. Statistic information is derived from the extracted field values. And, a statistical information field value of a data structure associated with the streaming service flow is updated with the least significant bits of the derived statistic information to achieve compactness in storing statistic information in support of high density streaming service flow provisioning.

In accordance with a further aspect of the invention, the method for tracking RTCP statistics includes steps of: generating an interrupt to an external processor, and providing the stored least significant bit values held in the statistic information field values of the data structure to the processor to update corresponding registers associated with the processor, the registers storing, at least, most significant bits corresponding to the derived statistic information.

In accordance with a further aspect of the invention, the method for tracking RTCP statistics in generating the interrupt, includes a step of: generating the interrupt upon experiencing one of a rollover condition in updating a statistic information field value, a first update instance of a statistic information field value, and a trigger instance.

In accordance with yet another aspect of the invention, the method for tracking RTCP statistics includes a step of: requesting the stored least significant bit values held in the statistic information field values of the data structure to be provided to the processor to update corresponding registers associated with the processor, the registers storing, at least, most significant bits corresponding to the derived statistic information.

The advantages are derived from hardware data storage structure and software data storage structure specifications which take into account: the arrival rate of RTCP statistics reports, the rate of generation of RTP packets, expected communication session duration, statistics information processing bandwidth, etc.; to provide a balance between hardware statistics information tracking, timely update of statistics information processed by software, while reducing statistics information update overheads in support of high density data streaming solutions.

### BRIEF DESCRIPTION OF THE DRAWINGS

The features and advantages of the invention will become more apparent from the following detailed description of the preferred embodiment(s) with reference to the attached diagrams wherein:

FIG. 1 is a schematic diagram showing a format of an RTP encapsulated payload in accordance with RFC 1889;

FIG. 2 is a schematic diagram showing a format of a sender's RTCP statistics report packet in accordance with RFC 1889;

FIG. 3 is a schematic diagram showing a format of a receiver's RTCP statistics report packet in accordance with RFC 1889;

FIG. 4 is a schematic diagram showing, in accordance with an exemplary embodiment of the invention, elements implementing an exemplary media gateway, and process steps performed in support of VoIP streaming services; and

FIG. 5 is a schematic diagram showing an exemplary format of a data structure used in tracking statistics information in accordance with the exemplary embodiment of the invention.

It will be noted that in the attached diagrams like features bear similar labels.

### DETAILED DESCRIPTION OF THE EMBODIMENTS

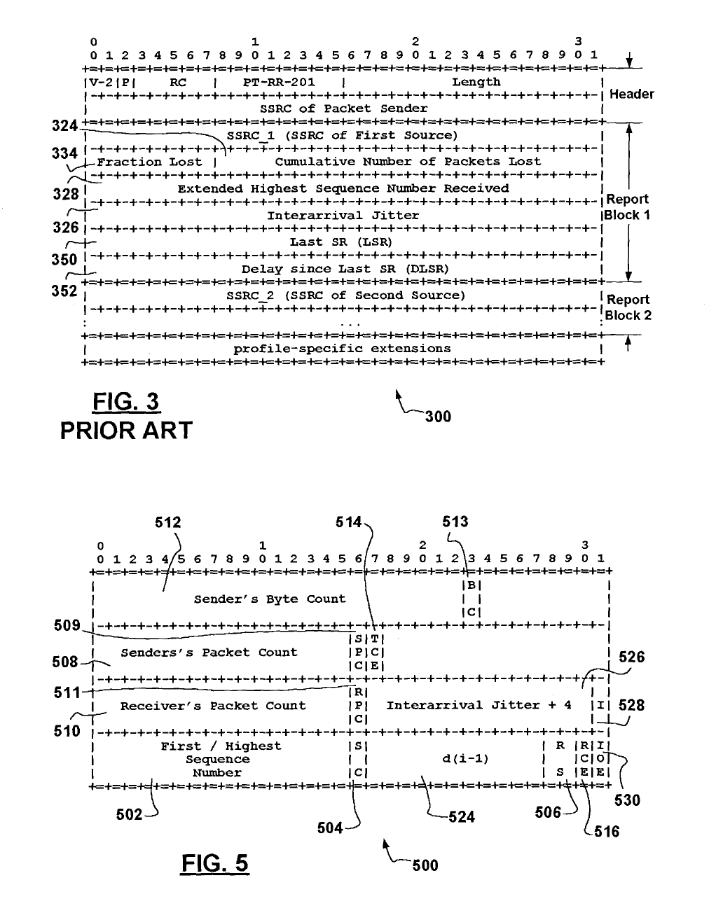

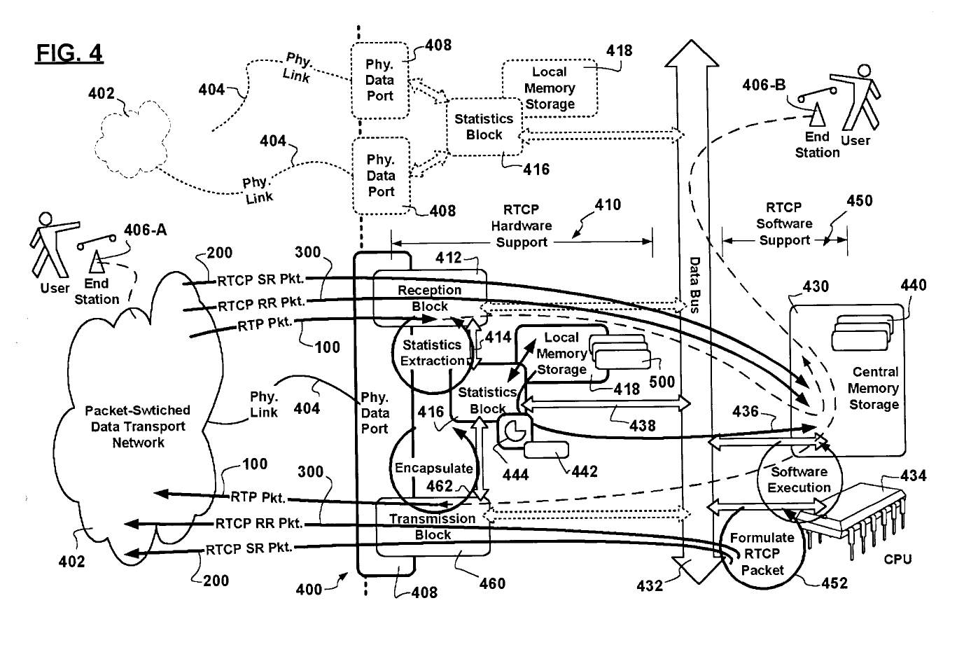

FIG. 4 shows exemplary elements of an exemplary device 400, such as a media gateway, processing RTP and RTCP packets in provisioning VoIP streaming services. The media gateway 400 provides VoIP support to end station 406-B. The media gateway 400 is connected to a communications network 402 via a physical link 404 and receives packets from VoIP sources of which the simplest is an end user station 406-A. The received packets include, without limiting the invention: RTP packets 100 carrying voice payloads associated with a conferencing context, RTCP Sender's Report (SR) packets 200, and RTCP Receiver's Report (RR) packets 300.

In accordance with an exemplary embodiment of the invention, RTCP statistics processing is provided via a hardware solution 410 to handle the collection 414 and storage 416 of RTCP statistics, and a software solution 450 to handle the formulation 452 of RTCP RR packets 300. The advantage of this division of tasks is derived from an optimization of hardware and software resource utilization wherein: the RTCP hardware 410 provides high-rate simple statistics processing, and the RTCP software 450 provides low-rate complex statistics processing.

The RTP packets 100, the RTCP SR packets 200, and the RTCP RR packets 300 are received via the physical link 404 by a receiver block 412. The receiver block 412 inspects all received packets.

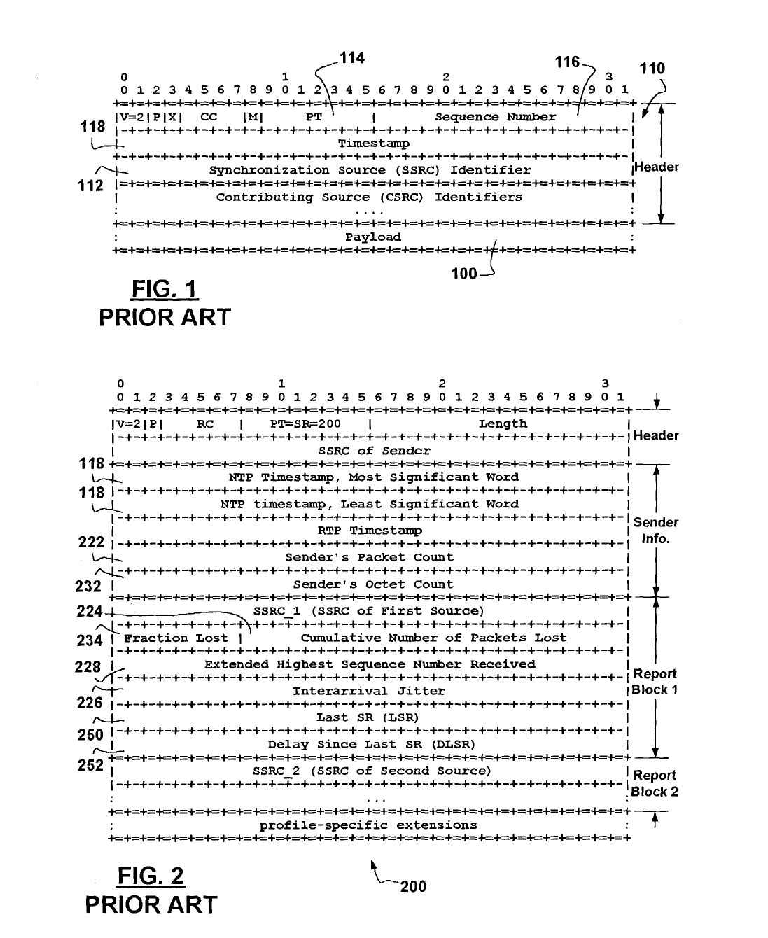

Making reference to FIG. 2, particular attention will be given herein to the statistics fields of the sender's RTCP statistics report packet 200, including:

Sender's Packet Count 222: The number of RTP data packets transmitted by the sender since connection setup—32 bits;

Sender's Octet Count 232: The number of payload bytes transmitted via RTP data packets since connection setup—32 bits;

Fraction Lost 234: The fraction of RTP data packets from the given source lost in transit since the last RTCP reception statistics packet—8 bits;

Cumulative Number of Packets Lost 224: The number of RTP data packets from the given source lost in transit since connection setup—24 bits;

Extended Highest Sequence Number Received 228: The highest sequence number received so far (the RTP sequence number is only 16 bits, the upper 16 bits of the 32 bit field reflects the number of rollovers)—32 bits; and

Interarrival Jitter 226: An estimate of the difference in packet spacing at the receiver station compared to the sender station over all packet pairs—32 bits.

A statistics block 416, interacts with the reception block 412 to extract 414 the statistical information provided in received RTCP SR packets 200, RTCP RR packets 300 and updated by header information extracted from RTP packets 100. The statistics block 416 keeps track of the extracted statistics information for each provisioned VoIP stream in a local memory storage 418.

The RTCP statistics tracking hardware 410 may be implemented as a single chip solution associated with a single port 408 or multiple ports 408 of an exemplary media gateway 400.

Although only the above six fields are tracked by the RTCP hardware 410 per VoIP stream, a large amount of memory storage is required for high density VoIP applications. Off-chip (external/device central) memory 430 can be used to provide ample statistical information storage, however writing a large number of bytes of statistical information employing a data bus 432 for each packet received utilizes the bandwidth available. Unfortunately, the memory access bandwidth is an overall system bottleneck, as a consequence of high-rate RTP packet payload storage and retrieval in provisioning VoIP services and should be conserved.

In accordance with the exemplary embodiment of the invention, statistics counters tracking RTCP statistics are implemented partly in hardware and partly in software. The most significant counter bits which change least during a VoIP session are held in software, while the least significant counter bits which change most frequently are maintained in hardware. A compact RTCP statistics data structure 500 for storage of statistical information in the local memory storage 418 is provided and has an exemplary format presented in FIG. 5. The invention is not intended to be limited to the RTCP data structure 500 presented. The exemplary bit mask presented is not intended to preclude other arrangements of the data structure fields, the same fields can be arranged in similar ways without detracting from the overall spirit of compactness.

In accordance with the exemplary embodiment of the invention, the 192 bits extracted 414 from each RTCP SR packet 200, are used by the statistics block 416 to update the compact data structure 500 uses a total of 128 bits which is arranged in four rows of 32 bits.

In accordance with the exemplary embodiment of the invention, the arrangement of the statistical information fields presented in FIG. 5, enables only two 32 bit rows to be accessed at any time. When an RTP 100 or RTCP RR 300 packet is sent for a VoIP stream via the port 408, only the first pair of rows needs to be accessed. When an RTP 100 or RTCP SR 200 packet is received for the VoIP stream via the port 408, only the second pair of rows needs to be accessed. In accordance with an implementation in which the access width between the statistics block 416 and the local memory storage 418 is 64 bits, then only a single memory access cycle is needed per packet.

The fields of the hardware RTCP statistics data structure 500 are presented as follows:

Two Transmit 514 and Receive 516 Context Enable bits (TCE and RCE) indicate whether a VoIP flow has been designated for statistics collection in the corresponding direction, and consequently, whether the values stored in the corresponding data structure's fields (500) are valid.

In order to compute packet loss, the number of packets expected is needed to be known. The number of packets expected can be calculated for each VoIP stream provisioned from: the value of the highest sequence number received so far, minus the value of the first sequence number received. The value of the first sequence number is assigned by the transmitter (406-A) at connection setup time. Storing the first observed sequence number value is inefficient since it is seen once only, used once only, and then kept untouched thereafter. The fields “First/Highest Sequence Number” 502 and “Sequence Number Carry” (SC) 504 are provided for this purpose.

In accordance with the exemplary embodiment of the invention, the value of the first sequence number is to stored in the field 502 only for a short while to report it to a CPU 434 executing the RTCP statistics software solution 450. Once reported to the CPU 434, field 502 is reused to store the value of the highest sequence number encountered so far. The RS (Receive Status) bits 506 are used to specify whether field 502 is storing the value of the first or highest sequence number. The strategy is employed because the highest sequence number value (116) is monotonically increasing, no information is lost by neglecting the field 502 for a while, then later updating it once the first sequence number is reported.

RTP sequence numbers provided in RTP packets 100 are 16 bits long, and therefore the field 502 must be 16 bits. The RTCP statistics packet format specifies an extended sequence number values in fields 228 and 328 respectively which are 32 bits long. In accordance with the exemplary embodiment of the invention, the 16 upper most significant bits are maintained by the software 450, in order to conserve memory storage in the local memory storage 418 and conserve bandwidth in conveying 436 these values via the data bus 432. The SC bit field 504 is set to a high logic value whenever the sequence number tracked rolls over, and is used as a signal to the software 450 that the extended most significant sequence number bits must be incremented.

The time interval between software updates 436 must be chosen so as to ensure that no more than one rollover for the field 502 may occur between consecutive software updates 436. Therefore the update time interval is dependent on the packet arrival rate.

The two bits of the Receive Status (RS) field 506 are used to control field 502 used to specify both First and Highest Sequence Numbers. An exemplary specification for the RS field 506 includes:

“00”—Packet flow for the VoIP context is enabled, but the first packet has not been received yet. When the first packet arrives, set the first sequence number field value.

“01”—Packet flow for the VoIP context is enabled, the first packet has been received, but the CPU 434 has not yet read the first sequence number field 502. Do not update field 502.

“10”—Packet flow for the VoIP context is enabled, the first packet has been received, and the CPU 434 has completed reading the first sequence number value. Update field 502 to indicate the highest sequence number value received so far.

The Sender's Packet Count 508 and SPC 509, and Receiver's Packet Count 510 and RPC 511 fields are used to store the cumulative number of packets transmitted and received for a given VoIP context. The SPC 509 and RPC 511 bits indicate counter 508/510 rollovers, and will be used as a signal to the software to update higher order bits as required.

The maximum number of bits needed for the Sender's Packet Count 508, and Receiver's Packet Count 510 fields is 16, because 16 bit are used in RTP packets 100 for storing sequence number values as mentioned above with respect to the first/highest sequence number field 502. If more than 16 bits were allotted to packet count tracking, we would rollovers would have to be reported to the CPU 434 every ˜2¹⁶-2¹⁷ packets anyway. On the other hand, using many fewer bits than 16 would increase exponentially the required interaction between software 450 and hardware 410, which would overuse the very scarce CPU access bandwidth (432).

Assuming a worst case scenario in which one packet is generated every 125 μs (the base sampling time unit for VoIP packet-voice applications), per flow, one rollover update interaction between hardware 410 and software 450 counter values will be required every 2¹⁷×0.125 ms, or about 16 seconds. This update rate enables even low-end processors 434 to support hundreds of flows in support of VoIP solutions.

Cumulative Packet Loss since VoIP connection setup is equal to Highest Sequence Number 502−First Sequence Number (502)−Receiver's Packet Count 510, and can be easily calculated by the CPU 434 when required for RTCP packet formulation 452. Fraction Lost can similarly calculated, except that the time period of evaluation runs “from the last RTCP reception statistics packet was sent” rather than since connection setup. The software 450 can access these values by polling the hardware data structures 500 when needed.

Fields Sender's Byte Count 512 and “BC” 513 are used to store the cumulative number of bytes transmitted so far for a given VoIP flow. The BC 513 bit indicates counter 512 rollover, and is used as a signal to the software 450 to update higher order bits tracked by the software 450 if required. As a VoIP payload conveyed in an RTP packet 100 will typically not exceed 128 bytes (or 128×125 μs=16 ms of voice samples), the length of the Sender's Byte count field 512 to exceed that of the Sender's Packet count field 508 by more than 7 bits.

Under ideal operating conditions, each VoIP packet (100) arrives from the transmitting station 406-A exactly when “expected,” to be played out immediately by the receiver station 406-B. In accordance with the ideal case, even though each VoIP packet (100) may suffer a network delay, the variation in this incurred delay from VoIP packet to VoIP packet is so small that the receiver station 406-B or media gateway 400 can predict with near certainty when the next VoIP packet will arrive. This predictability would make it safe for the receiver station 405-B to play out the voice sample packet payload as soon as that VoIP packet (100) arrives, because a new set of voice samples is certain to arrive exactly when the previous set has finished playing out without any discernible audio gaps.

In practice however, communication networks 402 do experience some variation in latency from VoIP packet to VoIP packet, otherwise known as network jitter. Jitter effects may be hidden from the listener (406-B) by artificially inserting at the receiver station 406-B a short “playback delay” before playing out the next received voice samples. The playback delay introduced, such as comfort noise, may be comparatively so small that the conversation/conference can proceed normally, without either party experiencing delayed responses. However, the inserted playback delay is long enough to compensate for variations in latency incurred in packet network 402 from one VoIP packet to the next. The artificial insertion of the playback delay also means that the receiver station 406-B or a media gateway 400 associated therewith will need additional memory storage space to queue arriving VoIP packets, prior to playback after the inserted playback delay. The additional memory storage space is referred to as a “jitter buffer”.

The interarrival jitter is highly variable and must be calculated to monitor the difference in VoIP arrival packet latency from one VoIP packet to the next, also the absolute value of these differences must be tracked over time. Two fields dⱼ₋₁ 524 and “Interarrival Jitter+4” 526 are maintained by the statistics block 416 for each VoIP flow in a corresponding statistics data structure 500.

In accordance with the exemplary embodiment of the invention, the number of bits required to store estimates of interarrival jitter values 526 to achieve storage compactness is affected by the receiver station 406-B (or media gateway 400) compensating for jitter effects by inserting playback delay. Inserting too much playback delay causes the conversation/conference to experience uncomfortable delays. A natural maximum jitter toleration limit to in voice services provisioning. In practice, the maximum tolerated jitter is 128 ms, using 125 μs the “heart beat” unit of measurement in voice services provisioning, 10 bits (i.e. 210×125 μs=128 ms) are sufficient to track the experienced jitter.

Packet latency can be determined from the difference dⱼ between VoIP packet j's arrival time at the receiver station 406-B or the media gateway 400, and j's creation time at the transmitter station 406-A. A VoIP packet's creation time is contained in the 32-bit timestamp 118 in the RTP header, see FIG. 1. The arrival time for each VoIP packet is determined by consulting a 32-bit pseudo-time counter (incremented every 125 μs by a local clock) upon arrival. Although it can be assumed that the receiver's and the transmitter's clocks have identical frequencies, the time values reported by each one of the two clocks at any given time are unrelated. There is no restriction on the set of values that dⱼ can take on. Reasons for this arrangement are presented in the above mentioned RFC1889 and the above referenced U.S. patent application Ser. No. 10/103,299.

As indicated earlier, the absolute value of the difference Dⱼ in packet arrival latency must be determined from one VoIP packet to the next, which is given for each j by:

Dⱼ=|dⱼ−dⱼ₋₁|.

In order to compute Dⱼ, the incurred latency dⱼ₋₁ 524 of the previous packet must be stored in the data structure 500 for each flow.

Having determined a new data point Dⱼ, corresponding to the difference in packet latency between the current and the previous VoIP packet, Dⱼ is used to compute the running estimate of jitter J given by:

J=J+(Dⱼ−J)/16

This equation represents a first order recursive low pass filter, which incorporates the new data point Dⱼ into the running estimate of the jitter J, which provides a relatively good convergence without pronounced oscillations.

It might first appear that 32 bits will be required for the dⱼ₋₁ field 524, since the set of values that dⱼ₋₁ can take on cannot be restricted. Because J is essentially a running estimate of Dⱼ for all j, it becomes apparent that if J is a number value that can be represented using 10 bits, then so can Dⱼ. Therefore, although dⱼ and dⱼ₋₁ can each be any arbitrary 32-bit value, their absolute difference Dⱼ can always be expressed in 10 bits. A proof that a maximum of 11 bits are necessary to express and store dⱼ in the data structure 500 is provided in the appendix.

In practice it was found that 14 bits are more appropriate for storing the value of the jitter estimate J for additional precision. An additional 4 bits correspond to fractional components of the 125 us time unit are used in order for the interarrival jitter field 526 to be expressed as an integer as stipulated by the standard RTCP packet format (RFC1889).

The need for the higher precision stems from the “divide by 16” operation used in calculating in the jitter as presented above. In hardware (410), dividing by 2^{m} is implemented by shifting the binary representation of a number value m bit places to the right. Suppose (in accordance with a critical case), if for all j, the value of Dⱼ=15, the jitter calculation will proceed as follows:

J=0+(15−0)/16=0+15/16=0,

because the binary representation of decimal “15” is “1111”, which becomes 0 after being shifted 4 bit places to the right. In this case, the value of J will never converge to its proper value of 15. Therefore, the decimal portion of the jitter J must be calculated and stored to a precision of 1/16, therefore the need for the extra 4 bits.

The CPU 434 interacts 438 with the statistics module 416. As indicated above that some of the statistics counters will be maintained partly in hardware 410 via flow specific data structures 500, and partly maintained by the CPU 434 in the central memory storage 430 in data records 440. When a hardware counter rolls over, a mechanism is required to signal the CPU 434 that the higher order bits stored in the records 440 must be incremented. As well, the mechanism is required to signal the CPU 434 the states of the First/Highest Sequence Number field 502 used to store the first sequence number only for a short while, before it is reported to the CPU 434 and the field is reused to track the highest sequence number received thereafter.

There must be a well-defined flow of information between: the hardware statistics collection and maintenance, and the software statistics information processing, statistics report generation, and RTCP packet formulation. Two methods of interaction are proposed, and both can be supported simultaneously and applied in a configuration-dependent fashion.

Both methods are based on an address counter 442 incremented by a low frequency clock 444. The period of the low frequency clock 444 is preferably less than the maximum allowable time interval between consecutive hardware/software interactions, divided by the total number of VoIP flows supported (depending on the particular implementation of the exemplary embodiment of the invention, the total number of VoIP flows supported refers to a media gateway 400 device as shown in dotted representation in FIG. 4, the total number of VoIP flows supported by a physical port 408 as shown in the solid representation in FIG. 4). For example (with reference to our earlier discussion about packet count rollover), suppose that the maximum allowable interval between consecutive hardware/software interactions is 16 seconds. If the device supports 128 flows, then the (low) clock frequency must be at least 8 Hz.

On every clock edge, the address counter 442 increments, and the VoIP flow referenced by this address will report 436 its status to the CPU 434, in a manner dependent on settings of “I” 528 and “IOE” 530 bits. If bit 1528 is set, then the referenced VoIP flow will interrupt the CPU 434 every time it is selected via the address counter 442 to report values held in the corresponding data structure 500. If bit 1528 is not set, but bit 10E 530 is set, then the selected VoIP flow will interrupt the CPU and report values held in the corresponding storage structure 500 only when an “event” has occurred since the last selection. An “event” includes: a rollover of one or more counters for that VoIP flow, the availability of the first sequence number for that VoIP flow, etc.

The RTCP statistics are tracked by the statistics block 416 as extracted from RTP packets 100 between RTCP SR 200 and RR 300 packet receipts. The RTCP statistics information held in a flow data structure 500 may need to be reported to the CPU 434 every time the flow is scanned to update records 440 and provide the CPU 434 with the necessary, up to date information, for the formulation 452 of RTCP packets 200/300.

From a different point of view, it is RTCP software's 450 responsibility to retrieve the necessary statistics information held in the local memory storage 418 in data structures 500 corresponding to each VoIP flow provisioned, and to incorporate (452) thereof into RTCP packets 200/300 prior to scheduling the transmission thereof. In accordance with one implementation of the exemplary embodiment of the invention, the low-frequency clock 444 is synchronized to the desired frequency of transmission of the RTCP packets 200/300. The RTCP hardware 410 will report 436 the statistics information for each VoIP flow precisely when software 450 is to formulate 452 an RTCP packet 200/300 for that flow. The CPU 434 is informed every time the VoIP flow is scanned, regardless of whether an “event” has occurred.

In accordance with another implementation of the exemplary embodiment of the invention, the CPU 434 polls the hardware data structures 500 whenever an RTCP packet 200/300 is formulated. In this case, hardware 410 does not need to regularly interrupt the CPU 434, except on events.

As the RTCP software 450 actually formulates 452 the RTCP packets 200/300, fields such as NTP timestamp (wall-clock time) 118, Last SR 250/350 (based on wall-clock time when the last statistics packet was sent), and delay since last SR 252/353 (time lapsed since the receipt of the last statistics packet from a given source, and sending a statistics packet back to it) can be transparent to hardware 410.

A transmission block 460, however, receives VoIP packet payloads shown dashed in FIG. 5, accesses the local memory storage 418 to derive the necessary information to encapsulate 462 the VoIP payload into an RTP packet 100 prior to conveying thereof over the physical link 404 into the communications network 402.

The embodiments presented are exemplary only and persons skilled in the art would appreciate that variations to the above described embodiments may be made without departing from the spirit of the invention. The scope of the invention is solely defined by the appended claims.

### APPENDIX

Proof Regarding Number of Bits Required to Store dⱼ₋₁

Given two 32-bit integers x and y that differ by no more than 1023, how many bits of x and y must be examined in order to correctly compute |x−y|? It is proven that 11 bits are sufficient.

Three cases are considered:

1) x>y In this case,

|x−y|=x−y=(xmodM−ymodM)modM,

where taking the modulus has no effect on the result if M>1024.

2) x<y In this case,

|x−y|=y−x=(ymodM−xmodM)modM,

where M>1024.

3) x=y In this case,

|x−y|=(xmodM−ymodM)modM=(ymodM−xmodM)modM=0.

It is concluded that x−y is always equal to either (x mod M−y mod M) mod M, or (y mod M−x mod M) mod M, where M≧1024.

To decide which of the two expressions is correct, observe that if x≠y,

(xmodM−ymodM)modM+(ymodM−xmodM)modM=M.

Therefore, if M=2048, then exactly one of the following must be true:

0<(xmodM−ymodM)modM<1024 A)

0<(ymodM−xmodM)modM<1024 B)

(xmodM−ymodM)modM=(ymodM−xmodM)modM=0. C)

Therefore, cases A-C can always be uniquely mapped to cases 1-3 if M=2048. In other words, 11 bits of x and y are sufficient.

We claim:

1. A hardware device processing Real-Time Control Protocol (RTCP) statistics in support of streaming services provisioned via packet-switched communications networks comprising:
a. a plurality of data structures, each data structure tracking summary statistics information regarding a corresponding provisioned streaming service flow, and
b. a statistics block inspecting, in real time, a Real-Time Protocol (RTP) encapsulated packet to extract RTCP statistics information therefrom to update a corresponding data structure, and encapsulating a streaming service flow payload with an RTP header updated with statistics information held in a data structure corresponding to the streaming service flow provisioned.

2. The device claimed in claim 1, further comprising a clock updating an address counter, the address counter specifying, on each tick of the clock, a streaming service flow for which the statistics information held in the corresponding data structure is scheduled to be reported to an external processor.

3. The device claimed in claim 1, the device comprises one of a media gateway communications network node, a media gateway component associated with a communications network node, a physical layer device associated with a communications network node, a physical port device, a single-chip physical port controller, a network appliance, and an IP phone.

4. The device claimed in claim 1, wherein the streaming service flow is unidirectional and a plurality of streaming service flows used in combination define a streaming service context.

5. The device claimed in claim 4, wherein the steaming service context comprises one of an audio conference session, a video conference session, and a data streaming service.

6. A method for tracking RTCP statistics information comprising steps of:
a. extracting field values from an RTP packet header of a received packet corresponding to a streaming service flow,
b. deriving statistic information from the extracted field values, and
c. updating a statistical information field value of a data structure associated with the streaming service flow with the least significant bits of the derived statistic information to achieve compactness in storing statistic information in support of high density streaming service flow provisioning.

7. The method claimed in claim 6, further comprising steps of:
a. generating an interrupt to an external processor,
b. providing the stored least significant bit values held in the statistic information field values of the data structure to the processor to update corresponding registers associated with the processor, the registers storing, at least, most significant bits corresponding to the derived statistic information.

8. A method as claimed in claim 7, wherein generating the interrupt, the method further comprises a step of generating the interrupt upon experiencing one of a rollover condition in updating a statistic information field value, a first update instance of a statistic information field value, and a trigger instance.

9. The method claimed in claim 6, further comprising step of requesting the stored least significant bit values held in the statistic information field values of the data structure to be provided to the processor to update corresponding registers associated with the processor, the registers storing, at least, most significant bits corresponding to the derived statistic information.
